(19) United States
(12) Patent Application Publication
(10) Pub. No.: US 2015/0115781 A1
(43) Pub. Date: Apr. 30, 2015

(54) Electrical Generator

(71) Applicant: Michael L Luparello, Lakewood, CA (US)

(72) Inventor: Michael L Luparello, Lakewood, CA (US)

(21) Appl. No.: 14/064,074

(22) Filed: Oct. 25, 2013

(51) Int. Cl. H02K 1/27

(52) U.S. Cl. CPC H02K 1/27
USPC 310/75 R

(57) ABSTRACT

A rotary electric generator. A rotor rotates around a fixed electrical coil. The rotor has a magnetic retainer housing a ring of alnico magnets. Cooling vanes separate and insulate the alnico magnets from turbine blades and facilitate the passage of air for cooling. Also included are roller bearing rings for minimizing friction of the rotor as it rotates. An exhaust port is also included for permitting the flow of exhaust gases. A housing houses the fixed electrical coil and the rotor. The housing includes propulsion gas ports to permit introduction of propulsion gases and the housing includes combustion chambers for combusting fuel. A turbocharger is included for receiving the exhaust gases and for compressing air for use in the combustion chambers. The fuel is combusted within the combustion chambers to create jets of hot gases. The jets of hot gases are directed via the propulsion gas ports onto the turbine blades causing the rotor to rotate about said fixed electrical coil to generate electricity. In a preferred embodiment the fuel is hydrogen. In another preferred embodiment the fuel is sugar ethanol.

This invention relates to electrical generators, and in particular, rotary electric generators.

### BACKGROUND OF THE INVENTION

The problem of pollution is one of the major issues in today's society. A major contributor to pollution is the burning of fossil fuels. In addition, the United States needs to reduce its dependence on foreign oil in order to become more energy independent. What is needed is an efficient electrical generator that is “green” (i.e., burns environmentally safe fuels).

### SUMMARY OF THE INVENTION

The present invention provides a rotary electric generator. A rotor rotates around a fixed electrical coil. The rotor has a magnetic retainer housing a ring of alnico magnets. Cooling vanes separate and insulate the alnico magnets from turbine blades and facilitate the passage of air for cooling. Also included are roller bearing rings for minimizing friction of the rotor as it rotates. An exhaust port is also included for permitting the flow of exhaust gases. A housing houses the fixed electrical coil and the rotor. The housing includes propulsion gas ports to permit introduction of propulsion gases and the housing includes combustion chambers for combusting fuel. A turbocharger is included for receiving the exhaust gases and for compressing air for use in the combustion chambers. The fuel is combusted within the combustion chambers to create jets of hot gases. The jets of hot gases are directed via the propulsion gas ports onto the turbine blades causing the rotor to rotate about said fixed electrical coil to generate electricity. In a preferred embodiment the fuel is hydrogen. In another preferred embodiment the fuel is sugar ethanol.

### BRIEF DESCRIPTION OF THE DRAWINGS

FIGS. 1 and 2 show a preferred embodiment of the present invention.

FIG. 3 shows preferred cooling vanes.

FIG. 4 shows a preferred housing.

FIG. 5 shows a preferred coil and rotor.

### DETAILED DESCRIPTION OF THE PREFERRED EMBODIMENTS

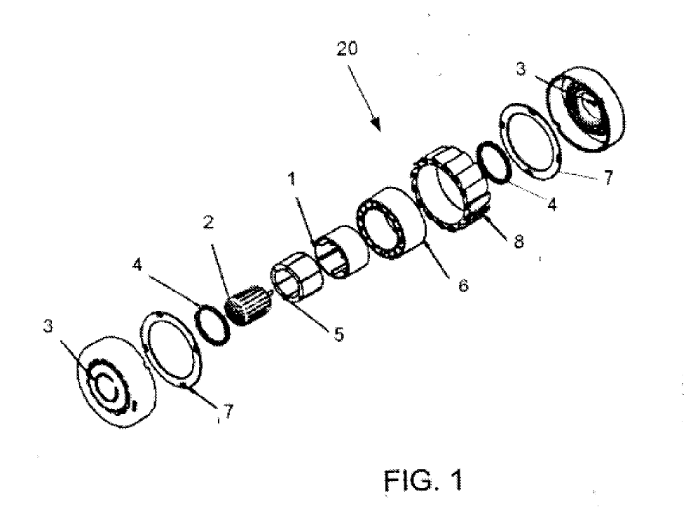

The present invention provides an electrical generator 20 (FIG. 1) having a fixed generator coil surrounded by a rotor containing alnico magnets, an air-gap cooling system and propulsion blades, which make up the machine's sole internal moving part.

### Rotor

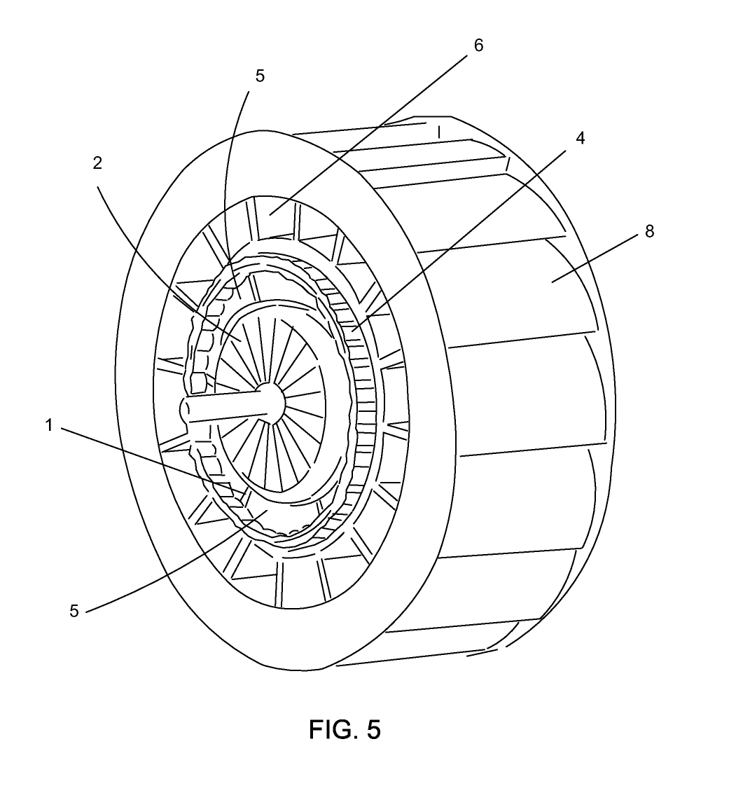

The rotor is a cast and machined structure that is housed in such a way that it will rotate around a fixed electrical coil 2 (FIG. 1). It contains (set in progressive steps axially out from the outer surface of coil 2): a ring of alnico magnets 5 housed in magnetic retainer 1; cooling vanes 6 (i.e., air flow vanes) for separating and insulating the magnets from turbine blades 8 and facilitating the passage of air for cooling; two roller bearing rings 4, sealing surfaces with exhaust ports 7 and ceramic turbine blades 8 (see also FIG. 5).

### Housing

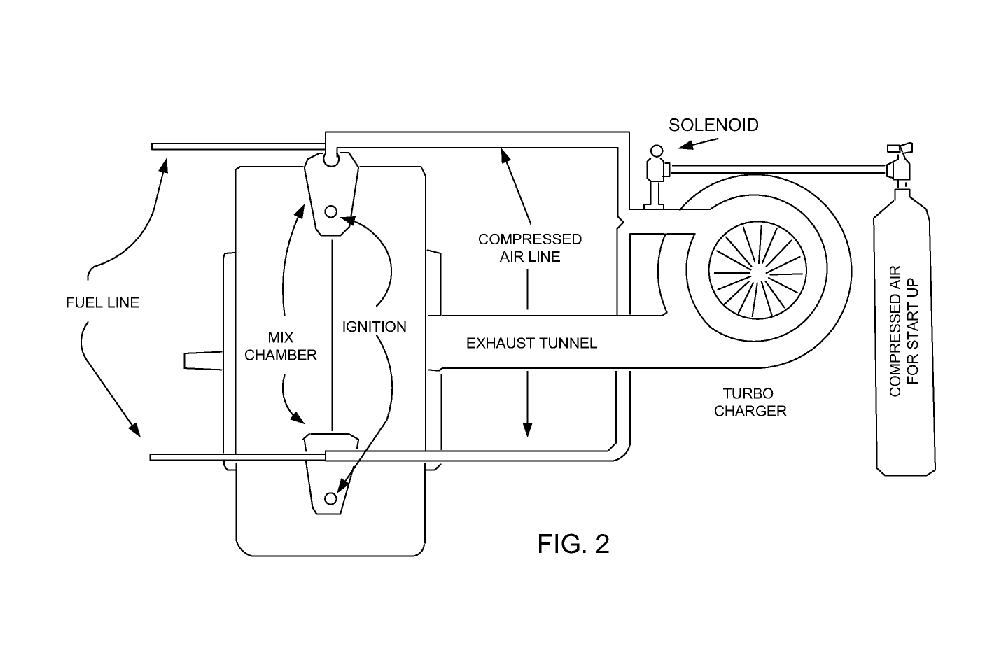

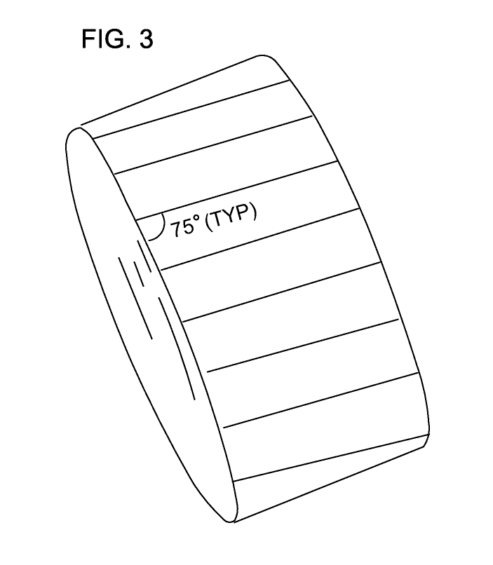

Coil 2 and the rotor are mounted within a cast and machined housing 3 which contains:
two continuous roller-bearing rings 4 which provide friction free rotation of the rotor;
cooling vanes 6 to provide air flow to facilitate cooling; in a preferred embodiment the cooling vane tunnels are preferably set at seventy five degrees (FIG. 3) to width of the rotor (FIG. 2);
two ring seals 7 set within the housing such that the bearing surface of the rotor that holds the turbine blades 8 will contact these seals in such a way as to provide a separation between the propulsive section and the generation section of the unit;
ports 13 (in four or more locations), spaced equilaterally around the external perimeter of the housing to permit introduction of propulsive gasses;
four (or more) combustion chambers 15 (FIG. 2), spaced equilaterally around the external perimeter of the housing and in alignment with the porting.

### Operation

Fuel is combusted within closed combustion chambers 15 creating jets of hot gasses. Those gasses are directed via ports 13 onto turbine blades 8, set in the outer perimeter of a rotor containing alnico magnets, causing the rotor to rotate about fixed electrical coil 2, thereby generating electricity. Exhaust gasses are directed to a turbo charger 11 (FIG. 2). The energy from the turbocharger is used to compress air for use in the combustion chambers.

Features of a preferred embodiment:
It is a single unit turbine and generator with but one moving part.
Because it is rotary, it is one of the most efficient system for creating electrical energy. Uniquely designed, though similar in its simplicity to the function of a hydroelectric generator, in a preferred embodiment it converts hydrogen or a sugar-based fuel into electricity in a method that is demonstrably more efficient than any existing hybrid design being offered at this time.
Fueled by hydrogen or sugar ethanol, this system significantly reduces our nation's dependence on foreign oil while substantially reducing greenhouse emissions.
Applications range from ships to trains, from automobile propulsion to large-scale backup generators for hospitals, office complexes to airports, to individual home systems; possibly entire power-grids. Also, it is a light weight and quiet portable generator with widespread potential uses, both military and civil.

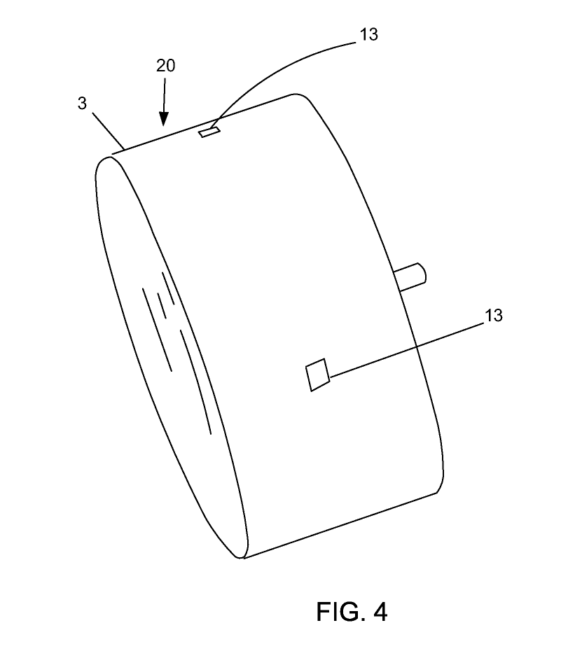

Although the above-preferred embodiments have been described with specificity, persons skilled in this art will recognize that many changes to the specific embodiments disclosed above could be made without departing from the spirit of the invention. For example, the parts shown in the drawings may be modified in size and shape. Also, ignition, speed control and computer systems are utilized in preferred embodiments. Also, turbine blade section 8 is preferably composed of ceramic material designed to operate within the temperature range of the fuels the generator will use and allowing for as close to zero expansion as is practicable. Also, intake port 13 shown in FIG. 4 illustrates one preferred location. The size and shape of the intake port may vary. Also, it should be noted that the present invention can be applied to a vast array of operational needs, and therefore many different sizes and load specifications are possible.

What is claimed is:

1. A rotary electric generator, comprising:
A. a fixed electrical coil,
B. a rotor rotating around said fixed electric coil, said rotor comprising:
i. a magnetic retainer,
ii. a ring of alnico magnets housed in said magnetic retainer,
iii. turbine blades,
iv. cooling vanes for separating and insulating said alnico magnets from said turbine blades and for facilitating the passage of air for cooling,
v. a plurality of roller bearing rings, and
vi. at least one exhaust port for permitting the flow of exhaust gases,
C. a housing for housing said fixed electrical coil and said rotor, said housing comprising
i. a plurality of propulsion gas ports to permit introduction of propulsion gases, and
ii. a plurality of combustion chambers for combusting fuel, and
D. a turbocharger for receiving said exhaust gases and for compressing air for use in said plurality of combustion chambers,
wherein fuel is combusted within said plurality of combustion chambers to create jets of hot gases, wherein said jets of hot gases are directed via said plurality of propulsion gas ports onto said turbine blades causing said rotor to rotate about said fixed electrical coil to generate electricity.

2. The rotary electric generator as in claim 1, wherein said fuel is hydrogen.

3. The rotary electric generator as in claim 1, wherein said fuel is sugar ethanol.
